(19) United States
(12) Patent Application Publication
(10) Pub. No.: US 2006/0067768 A1
(43) Pub. Date: Mar. 30, 2006

(54) Sheet post-process apparatus

(75) Inventors: Yasunobu Terao, Tagata-gun (JP); Mikio Yamamoto, Tagata-gun (JP); Tomomi Iijima, Mishima-shi (JP); Reiji Murakami, Yokohama-shi (JP); Hiroyuki Taki, Tagata-gun (JP)

Correspondence Address: FOLEY AND LARDNER LLP;SUITE 500, 3000 K STREET NW, WASHINGTON, DC, 20007, US

(73) Assignee: TOSHIBA TEC KABUSHIKI KAISHA

(21) Appl. No.: 11/008,230

(22) Filed: Dec. 10, 2004

(30) Foreign Application Priority Data
Sep. 28, 2004 (JP) 2004-281769

(51) Int. Cl. G03G 15/00

(52) U.S. Cl. 399/405

(57) ABSTRACT

A sheet post-process apparatus includes a waiting tray and a processing tray. The waiting tray is provided in the middle of a conveying path so that a downstream side end in a conveying direction of sheets is oriented upwardly. In the case where a post-process is required, sheets are made standby. The processing tray has a function which causes the sheets made standby on the waiting sheet to be dropped by self-weight. With this function, the processing tray receives the sheets moved to be dropped and the sheets conveyed from a conveying path without intervening the waiting tray, before carrying out the post-process. Bundles of sheets formed on the processing tray are stacked onto a storage tray by means of a sheet-conveying mechanism after they have been post-processed.

### CROSS-REFERENCE TO RELATED APPLICATIONS

This application is based upon and claims the benefit of priority from prior Japanese Patent Application No. 2004-281769, filed Sep. 28, 2004, the entire contents of which are incorporated herein by reference.

### BACKGROUND OF THE INVENTION

1. Field of the Invention

The present invention relates to a sheet post-process apparatus, such as a finisher, which is designed for installation at the outlet side of a multi-function peripheral (MFP).

2. Description of the Related Art

A finisher is known, which bundles a plurality of sheets by an MFP (Multi-Functional Peripheral) and staples them. In this finisher, the sheets conveyed from the MFP are sequentially conveyed to a processing tray, the conveyed sheets are stapled, and the stapled sheets are conveyed to a storage tray.

This finisher has a second tray for temporarily housing sheets ejected from an image forming apparatus, and, when ejection of the sheet-bundle from a first tray completes, saving them at a predetermined position, and dropping the temporarily housed sheets onto the first tray. However, in this case, there is a need for providing a mechanism for saving the second tray (refer to Jpn. Pat. Appln. KOKAI Publication No. 2001-89009).

Thus, equipment downsizing has been sufficiently achieved.

### BRIEF SUMMARY OF THE INVENTION

An object of the present invention is to provide a small sized sheet post-process apparatus.

According to an aspect of the present invention, there is provided a sheet post-process apparatus comprising: a plurality of rollers which receive and convey sheets conveyed from an MFP main body; a waiting tray provided in the course of a conveying path, and allocated to be inclined upwardly on a downward side in a conveying direction of the sheets so as to make standby the sheets conveyed from the rollers, in the case where a post-process is required; a conveying mechanism which causes the sheets made standby on the waiting tray to be dropped and moved by self-weight; a processing tray which receives the sheets dropped and moved from the waiting tray and the sheets conveyed from the conveying path without intervening the waiting tray, before carrying out a post-process; a post-process mechanism which carries out a post-process on a bundle of sheets aligned on the processing tray; a sheet-conveying mechanism which conveys the post-processed bundle of sheets from the processing tray; and a storage tray which stacks the bundle of sheets conveyed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a sheet post-process apparatus according to an embodiment of this invention;

FIG. 2 is a top view of the sheet post-process apparatus in the same embodiment;

FIG. 3 is a view illustrating an operation of a waiting tray in the same embodiment;

FIG. 4 is a view illustrating longitudinal alignment of the sheet post-process apparatus and a sheet bundle conveying mechanism in the same embodiment;

FIG. 5 is a view illustrating a transverse alignment mechanism of the sheet post-processing apparatus in the same embodiment;

FIG. 6 is a view illustrating an operation of a stapler of the post-process apparatus in the same embodiment;

FIG. 7 is a view illustrating a flow of a first sheet of paper between an input roller and a sheet-feeding roller in the sheet post-process apparatus in the same embodiment;

FIG. 8 is a view illustrating a flow of a first sheet of paper between the sheet-feeding roller and the waiting tray in the sheet post-process apparatus in the same embodiment;

FIG. 9 is a view illustrating a flow of a second sheet of paper between the sheet-feeding roller and the waiting tray in the sheet post-process apparatus in the same embodiment;

FIG. 10 is a view illustrating an operation of a waiting tray roller in the sheet post-process apparatus in the same embodiment;

FIG. 11 is a view illustrating an operation of the waiting tray roller in the sheet post-process apparatus in the same embodiment;

FIG. 12 is a view illustrating an operation of active drop in the sheet post-process apparatus in the same embodiment;

FIG. 13 is a view illustrating a flow of a third sheet of paper in the sheet post-process apparatus in the same embodiment;

FIG. 14 is a view illustrating an operation of the stapler in the sheet post-process apparatus in the same embodiment;

FIG. 15 is a view of illustrating a flow of a sheet-bundle between a processing tray and a storage tray in the sheet post-process apparatus in the same embodiment;

FIG. 16 is a view illustrating a flow when sheets are directly ejected from the waiting tray to the storage tray in the sheet post-process apparatus in the same embodiment; and

FIG. 17 is a view illustrating an operation for changing a position of the storage tray in the sheet post-process apparatus in the same embodiment.

### DETAILED DESCRIPTION OF THE INVENTION

An embodiment of this invention will be described, with reference to the accompanying drawings.

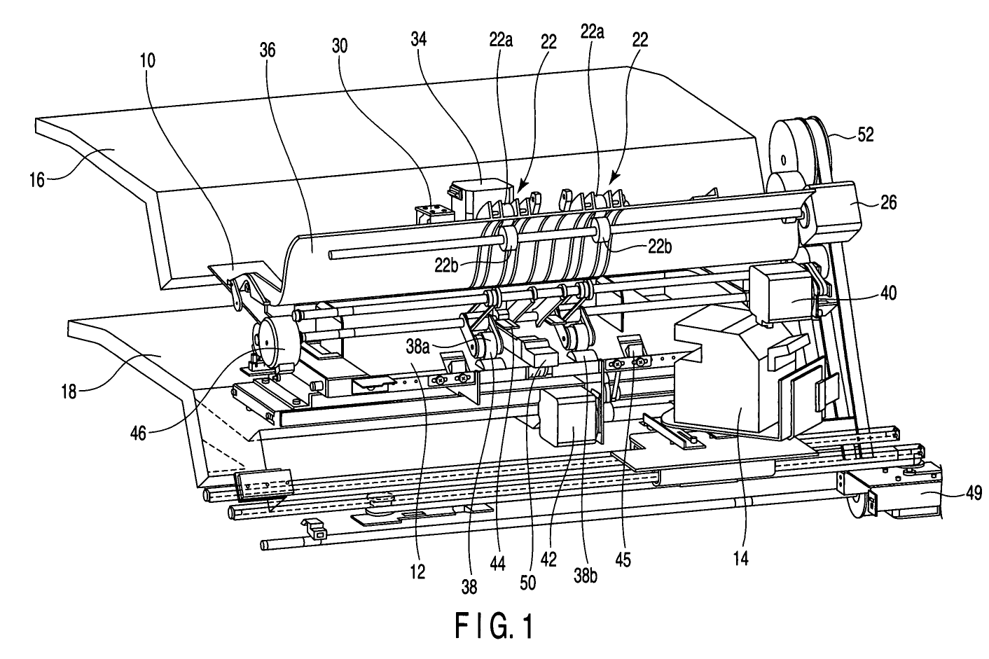

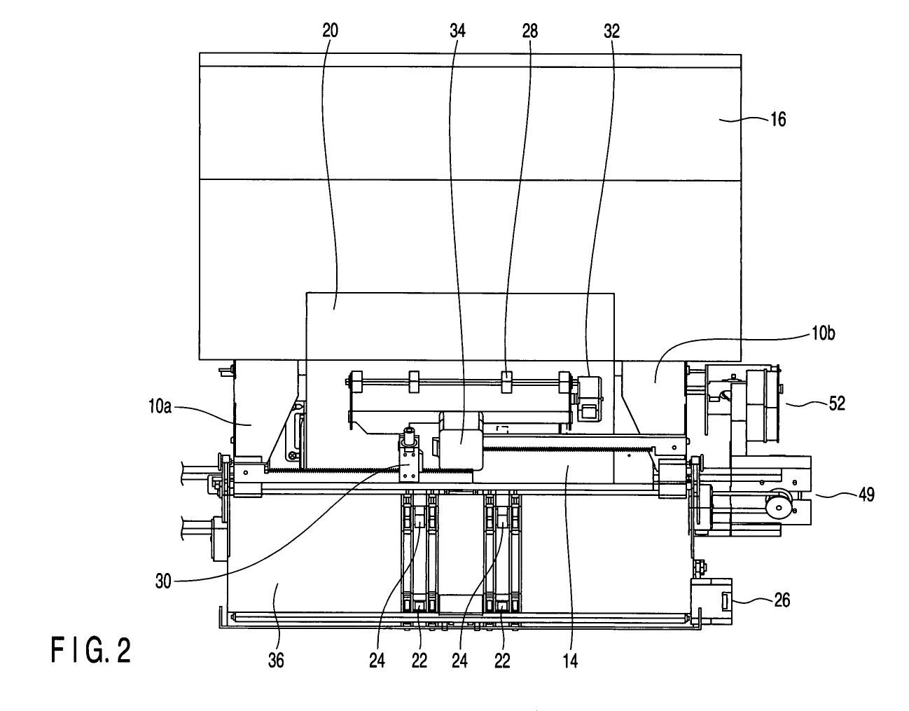

FIG. 1 is a perspective view of a sheet post-process apparatus according to this invention. FIG. 2 is a top view of the sheet post-process apparatus of the invention. As is shown in FIG. 1, the sheet post-process apparatus comprises a waiting tray 10, a processing tray 12, a stapler 14, a first storage tray 16, and a second storage tray 18.

A pair of input rollers 22 receive a sheet 20 supplied from an MFP and convey the sheet 20 to the sheet-feeding rollers 24. The sheet-feeding rollers 24 convey the sheet 20 to the waiting tray 10. An input-roller motor 26 drives the input rollers 22.

The input rollers 22 include an upper input roller 22a and a lower input roller 22b. Similarly, the sheet-feeding rollers 24 include an upper sheet-feeding roller and a lower sheet-feeding roller.

The waiting tray 10 is composed of a pair of two tray parts 10a and 10b which can move to the left and right, and receives a sheet in a state in which the waiting tray parts 10a and 10b are closed. A waiting tray roller 28 is provided for carrying out alignment of sheets in this state. The waiting tray roller 28 can move vertically, and its control is executed by a waiting tray roller drive source 30. In addition, rotation of the waiting tray roller 28 is carried out by a waiting tray roller motor 32. The waiting tray 10 is provided to be inclined at a predetermined angle so as to be oriented upwardly on the downward side in the conveying direction of the sheets 20.

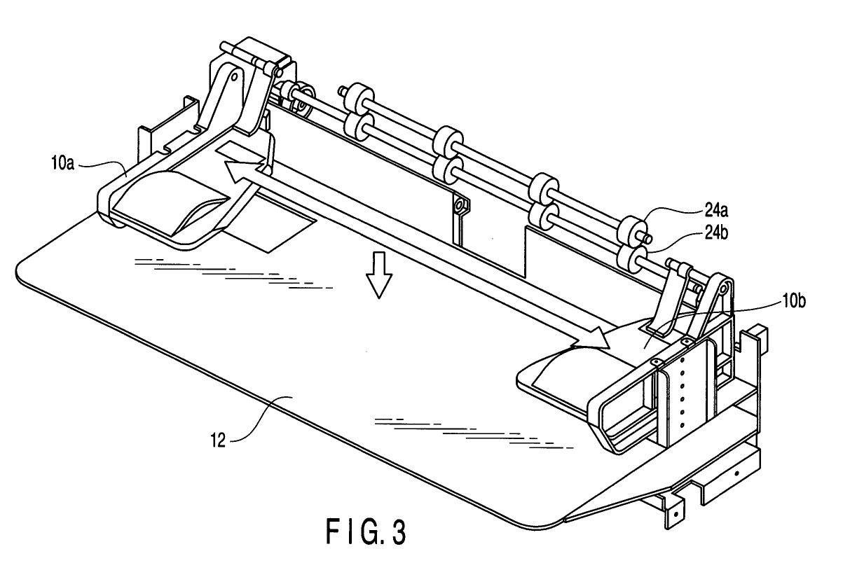

As shown in FIG. 3, a predetermined number of sheets are stacked on the waiting tray 10, the waiting tray parts 10a and 10b are opened by a waiting-tray motor 34, and the sheets 20 are dropped onto the processing tray by self-weight. This operation is referred to as active drop. The processing tray 12 is provided to be inclined at a predetermined angle so as to be oriented upwardly on the downward side in the conveying direction of the sheets 20.

As has been described above, the waiting tray 10 and the processing tray 12 are provided to be inclined at a predetermined angle so as to be oriented upwardly on the downward side in the conveying direction of the sheets 20. However, it is desirable that the waiting tray 10 be provided so as to be inclined more steeply.

The size relevant to a widthwise direction of the sheets 20 on the waiting tray 10 is smaller than the width of the sheets 20, and the size relevant to a widthwise direction of the sheets 20 on the processing tray 12 is smaller than the width of the sheets 20. In addition, the sheets 20 moved to be dropped from the waiting tray 10 are configured so as to be stacked across the processing tray 12 and the storage tray 16. With this configuration, the downsizing in the widthwise direction of the sheet post-process apparatus is achieved.

A paper path is provided to guide the sheets conveyed from the MFP to the waiting tray 10 and processing tray 12. This paper path is composed of a paper path ceiling 36.

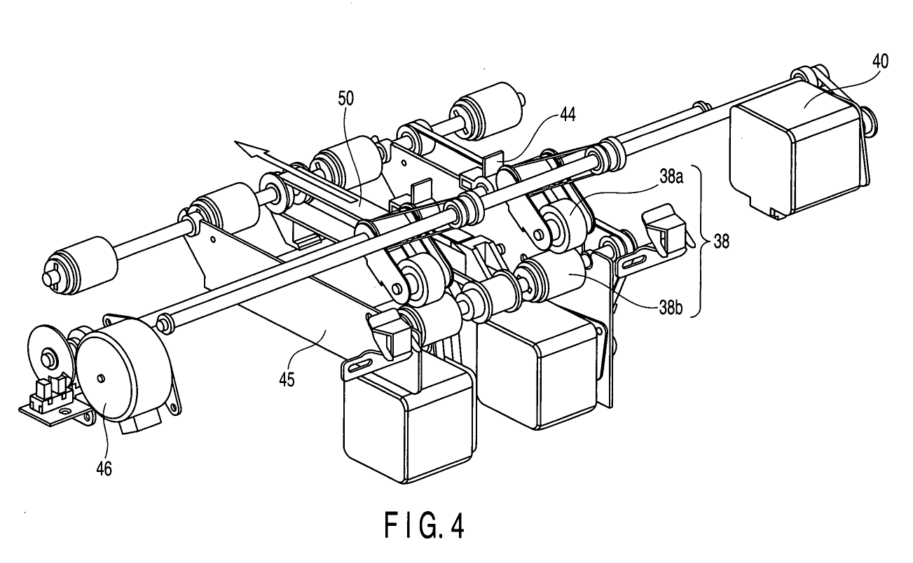

The sheets conveyed onto the processing tray 12 are subjected to longitudinal and transverse alignments. Longitudinal alignment is made by a longitudinal-alignment mechanism (longitudinal-alignment rollers) 38, as shown in FIG. 4. More precisely, an upper longitudinal-alignment motor 40 drives upper longitudinal-alignment rollers 38a of the mechanism 38, and a lower longitudinal-alignment motor 42 drives lower longitudinal-alignment rollers 38b of the mechanism 38, thereby aligning the sheet with a stopper as a reference. Paddles 44 are provided to facilitate the alignment. A paddle motor 46 drives the paddles 44.

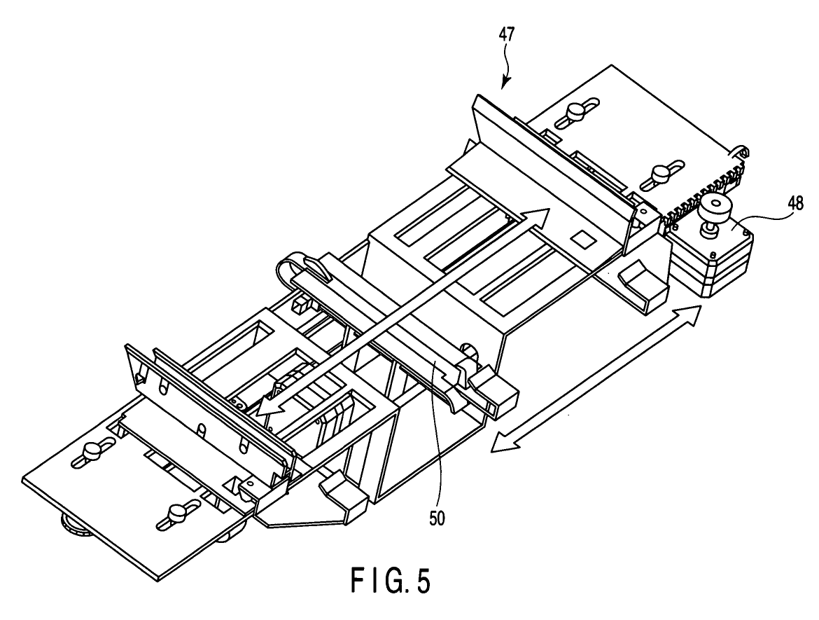

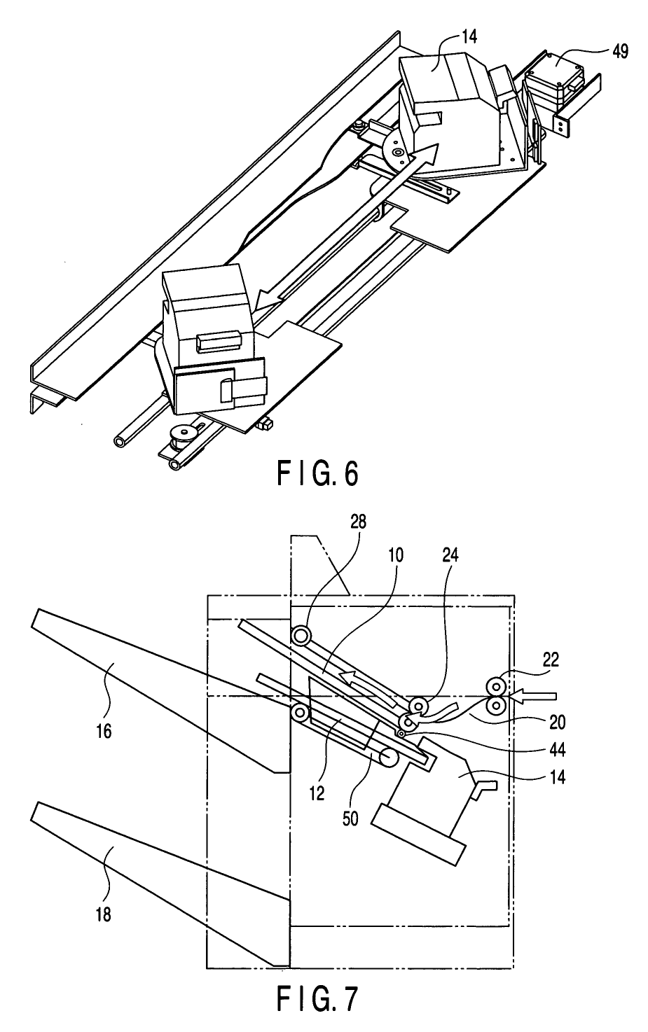

Transverse alignment is executed by a transverse-alignment mechanism 47 and a transverse-alignment motor 48, as shown in FIG. 5. When a predetermined number of sheets are aligned and stacked on the processing tray 12, staple processing is carried out by the stapler 14. As shown in FIG. 6, the stapler 14 is positioned by a staple-driving unit 49, and staple processing is controlled.

The stapled sheet bundles are conveyed to the storage tray 16 by a conveying mechanism 50. Selection of the storage tray 16 or storage tray 18 is made by vertically moving the storage tray 16 and 18 by means of a storage tray driving unit 52.

An operation of the sheet post-process apparatus according to this invention will be described with reference to FIGS. 7 to 18.

As shown in FIG. 7, the sheet 20 conveyed from the MFP is moved to the sheet-feeding rollers 24 via the input rollers 22 in the direction indicated by the arrow.

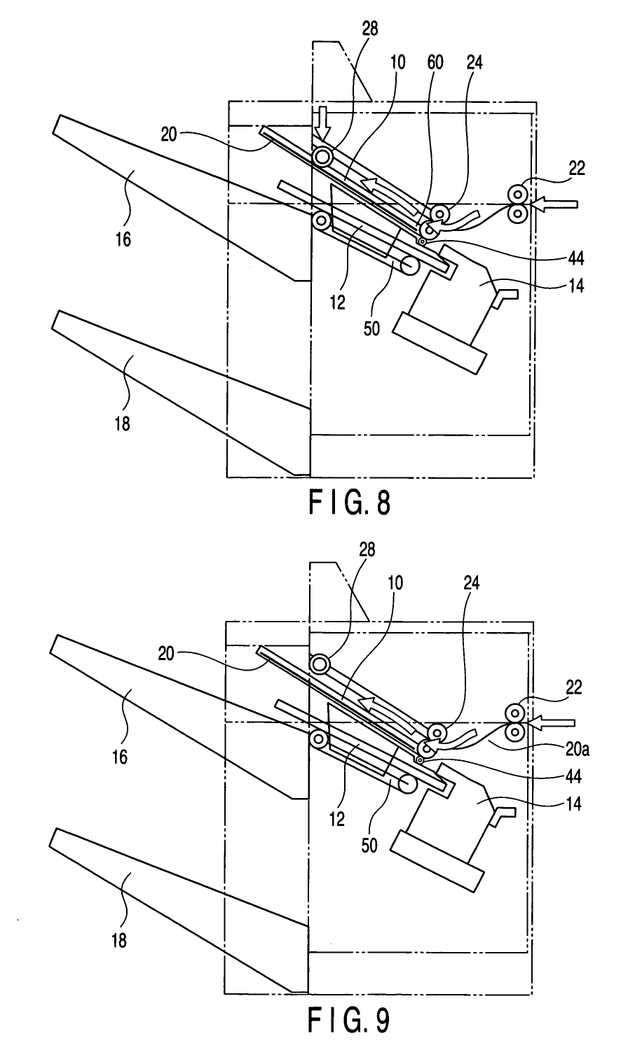

Next, as shown in FIG. 8, a first sheet is stacked onto the waiting tray 10 through the sheet-feeding roller 24. At this time, the waiting-tray rollers 28 move down in the direction indicated by the arrow, and align the trailing edge of the first sheet 20 at the rear (i.e., upstream) end 60 of the waiting tray 10.

Next, as shown in FIG. 9, the waiting-tray rollers 28 move up, and are ready to receive a second sheet 20a.

When the above receiving is ready, as shown in FIG. 10, the second sheet 20a is conveyed to the waiting tray 10. The waiting-tray rollers 28 move down, thereby aligning the trailing edge of the second sheet 20a at the rear end 60 of the waiting tray 10. Thus, a bundle 20b of two sheets 20 and 20a is formed in the waiting tray 10.

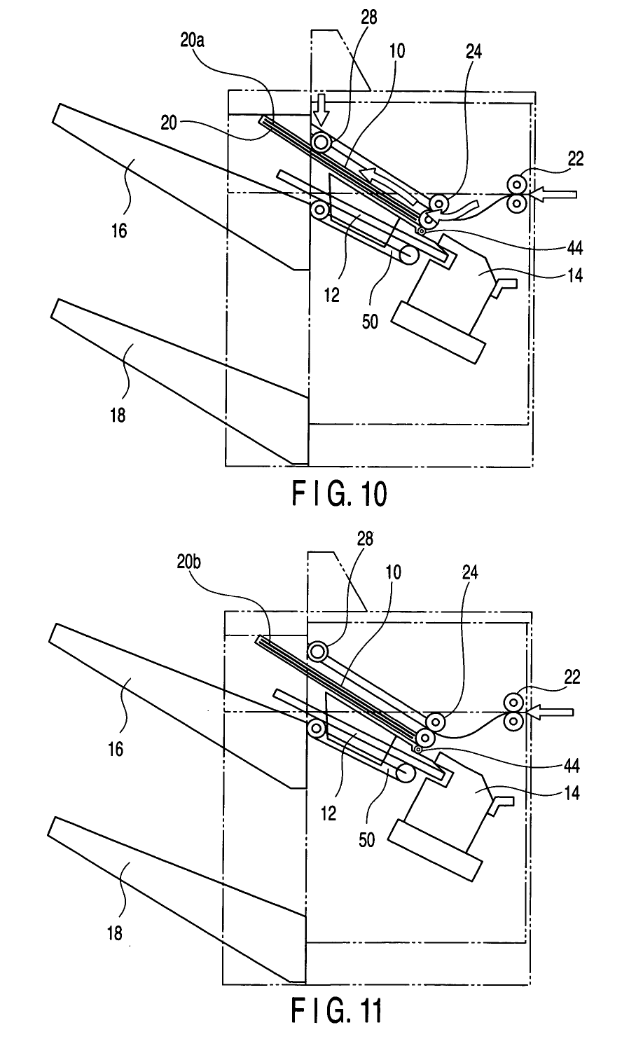

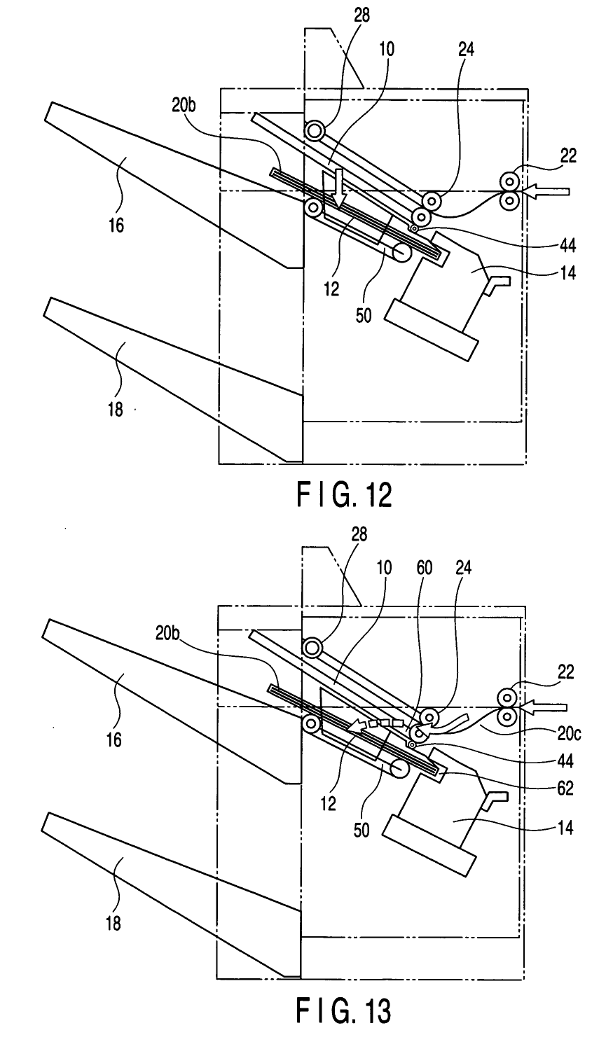

Next, as is shown FIG. 11, the waiting-tray rollers 28 move upwards. Further, the waiting-tray parts 10a and 10b open as shown in FIG. 3. The active drop is executed as shown in FIG. 12, and the bundle 20b is moved to be dropped onto the processing tray 12.

At this time, as shown in FIG. 12, since the waiting tray 10 is allocated so as to be inclined upwardly on the downstream side in the conveying direction of sheet bundle 20b, a speed of moving the sheet bundle 20b to be dropped onto the processing tray 12 can be improved. In addition, if the waiting tray 10 is provided to be inclined more steeply than the processing tray, the drop moving speed can further be improved.

As has been described above, the sheet bundle 20b is configured so as to be moved to be dropped. Thus, in the case where a roller or the like is used as conveying means, a conventional member which has been believed as a technique can be eliminated or simplified, thus making it possible to help achieve an inexpensive structure. In addition, as has been described above, there is provided a structure of making the sheet bundle 20b standby on the waiting tray 10, opening the waiting tray parts 10a and 10b, and dropping the sheet bundle 20b onto the processing tray 12. Thus, the downsizing of the sheet post-process apparatus can be achieved.

Then, the third and subsequent sheets 20c are conveyed from the sheet-feeding roller 24 directly to the processing tray 12 without intervening the waiting tray 10, as shown in FIG. 13. The conveyed sheets are stacked onto the two sheet bundles 20b, and a predetermined number of sheet bundles 21 are formed. At this time, the longitudinal and vertical alignment mechanisms 38 and 47 function, whereby longitudinal and transverse sheet alignments are executed.

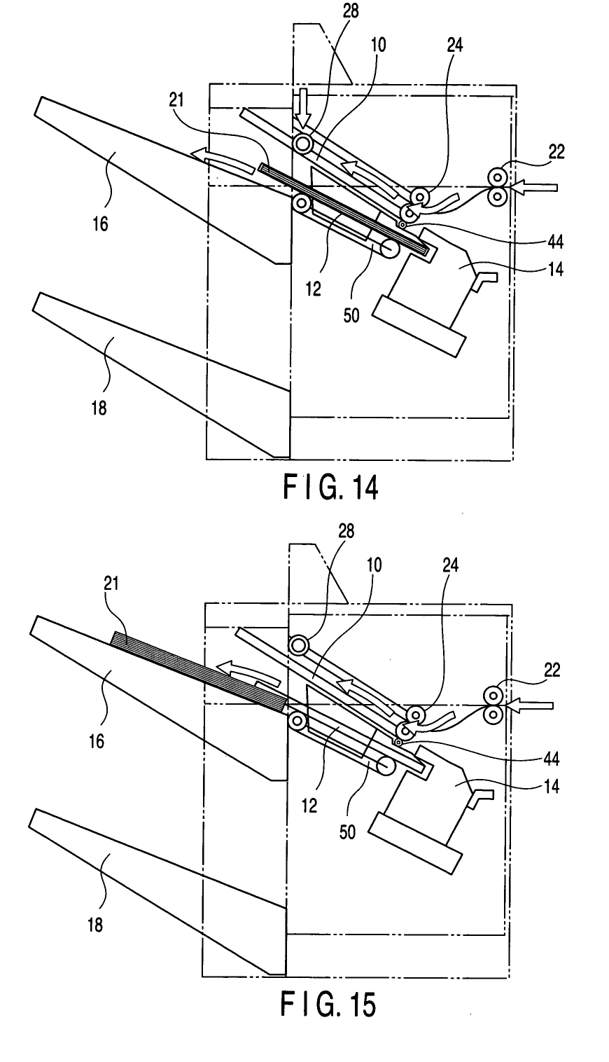

Next, as shown in FIG. 14, the sheet bundle 21 is stapled by the stapler 14. Then, as shown in FIG. 15, the sheet bundle 20 is conveyed to the storage tray 16 by the conveying mechanism 50, and a post-process is terminated.

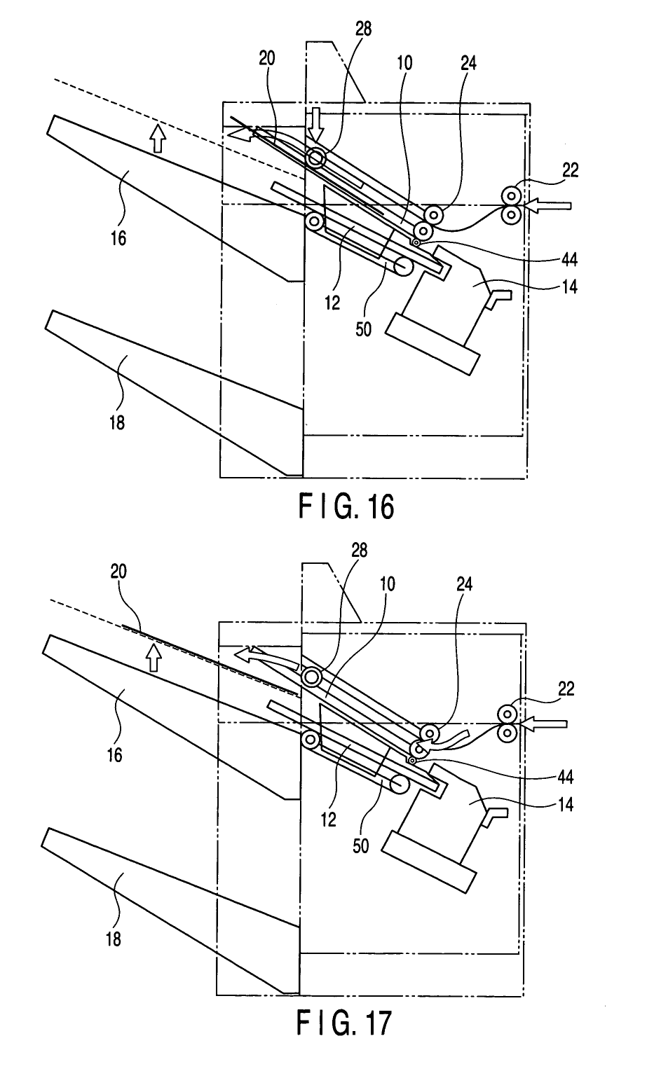

In the case where no post-process is required, the sheets are ejected from the waiting tray 10 directly to the storage tray 16 without intervening the processing tray 12, as shown in FIGS. 16 and 17. As is shown in FIG. 16, the sheets supplied from the MFP are sequentially conveyed to the first storage tray 16 via the input rollers 22, sheet-feeding rollers 24 and waiting tray 10. The waiting-tray rollers 28 move down, serving to convey the sheets 20. As depicted in FIG. 17, the first storage tray 16 is slightly lifted by the storage tray driving unit 52, and receives the sheets conveyed from the waiting tray 10.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sheet post-process apparatus comprising:
a plurality of rollers which receive and convey sheets conveyed from an MFP main body;
a waiting tray provided in the course of a conveying path, and allocated to be inclined upwardly on a downward side in a conveying direction of the sheets so as to make standby the sheets conveyed from the rollers, in the case where a post-process is required;
a conveying mechanism which causes the sheets made standby on the waiting tray to be dropped and moved by self-weight;
a processing tray which receives the sheets dropped and moved from the waiting tray and the sheets conveyed from the conveying path without intervening the waiting tray, before carrying out a post-process;
a post-process mechanism which carries out a post-process on a bundle of sheets aligned on the processing tray;
a sheet-conveying mechanism which conveys the post-processed bundle of sheets from the processing tray; and
a storage tray which stacks the bundle of sheets conveyed.

2. A sheet post-process apparatus according to claim 1, wherein the processing tray is allocated to be inclined upwardly on the downward side in the conveying direction of the sheets.

3. A sheet post-process apparatus according to claim 2, wherein inclination of the waiting tray is steeper than inclination of the processing tray.
